(19) United States
(12) Patent Application Publication
(10) Pub. No.: US 2022/0040014 A1
(43) Pub. Date: Feb. 10, 2022

(54) WHEELCHAIR FRAME AND WHEELCHAIR COMPRISING THE SAME

(71) Applicant: Invacare International GmbH, Witterswil (CH)

(72) Inventors: Michael Zeltner, Arlesheim (CH); Simon Brenner, Basel (CH); Martin HÜNIG, Reinach (CH)

(21) Appl. No.: 17/275,850

(22) PCT Filed: Sep. 2, 2019
(86) PCT No.: PCT/IB2019/057375

§ 371 Date: Mar. 12, 2021

(30) Foreign Application Priority Data
Sep. 14, 2018 (EP) 18194676.5

(51) Int. Cl. A61G 5/02; A61G 5/10

(52) U.S. Cl. CPC A61G 5/02; A61G 5/1054

(57) ABSTRACT

There is described a wheelchair frame including first and second side frame members each having a first, rearward section designed to be coupled to a seat portion of a wheelchair and a second, forward section designed to be coupled to a foot portion of the wheelchair wherein the rearward and forward sections are connected to one another to form a substantially L-shaped profile. Each of the first and second side frame members exhibits, at least in part, a varying cross-section and further has an intermediate section shaped to act as a hand grip, which intermediate section is interposed between the rearward and forward sections and exhibits a cross-section that differs from a cross-section of the rearward section and/or forward section. The rearward section, the intermediate section and the forward section are successive sections of a same integral piece that is shaped to exhibit the varying cross-section. The rearward section exhibits a substantially circular cross-section and the forward section exhibits a substantially polygonal cross-section, the intermediate section being a substantially rectilinear section and exhibiting a varying cross-section that transitions gradually from the substantially circular cross-section of the rearward section to the substantially polygonal cross-section of the forward section.

### TECHNICAL FIELD

The present invention generally relates to a wheelchair frame and a wheelchair comprising the same.

### BACKGROUND OF THE INVENTION

FIGS. 1A to 1F are perspective views of known commercially-available wheelchairs as sold by company Küschall AG, namely of Küschall's Advance, Champion, Compact, K-Series, The KSL, and Ultra-Light wheelchairs, respectively. All six wheelchairs, designated globally by reference numeral 1, essentially comprise a wheelchair frame 2 supported at a rear-end by a pair of rear wheels 3 and at a front-end by a pair of front caster wheels 4. The wheelchair frame 2 comprises two side frame members 7 (one on each side) each comprising a first, rearward section designed to be coupled to a seat portion 5 of the wheelchair 1 and a second, forward section designed to be coupled to a foot portion 6 of the wheelchair 1. As illustrated in FIGS. 1A to 1F, the rearward and forward sections of the side frame members 7 are connected to one another to form a substantially L-shaped profile. In the illustrated examples, each frame member 7 basically consists of a tubular member exhibiting a circular cross-section, which tubular member is curved to the desired L-shape profile.

The aforementioned known wheelchair frame designs are advantageous in that they lead to a lightweight, yet robust wheelchair construction. Furthermore, the tubular members of circular cross-section can conveniently be curved to the desired L-shape profiles.

The use of tubular members of circular cross-section however leads to certain limitations both from an aesthetic point of view and in terms of ergonomics.

Alternatives to the use of tubular members as constituents for wheelchair frames are also known in the art, such as extruded frame members, but these may typically lead to an increase of the production costs and are less satisfactory from an aesthetic point of view. It is furthermore more difficult to shape extruded frame members to match desired profiles.

US Patent Publication No. US 2009/0085321 A1 discloses a wheelchair with a wheelchair frame comprising first and second side frame members, each comprising a rearward section designed to be coupled to a seat portion of the wheelchair and a forward section designed to be coupled to a foot portion of the wheelchair, the rearward and forward sections being connected to one another via a curved intermediate section to form a substantially L-shaped profile. Each of the first and second side frame members may exhibit a varying cross-section over their length, in particular a cross-section changing from a circular cross-section at the rearward section to a generally oval cross-section at the forward section. As a matter of fact, this solution does not substantially differ from the known solutions illustrated in FIGS. 1A to 1F, and further improvements are desirable from the point of view of ergonomics in particular.

U.S. Pat. No. 5,409,247 A discloses a wheelchair with a wheelchair frame comprising first and second side frame members that are made of separate frame elements that are assembled one in the other. The assembly of multiple frame elements is not desirable from a practical point of view in that this negatively affects both robustness of the wheelchair frame as well as production costs.

U.S. Pat. No. 5,382,036 A discloses a molded, fiber-reinforced, tubular wheelchair frame assembly comprising first and second side frame members that are joined with other frame elements to form integral left and right side frame assemblies that are connected together by means of tubular frame members. While the formation of tubular molded parts using fiber-reinforced resins and fibers typically leads to a lightweight wheelchair frame assembly, the inherent production costs remain high and production of such wheelchair frame assemblies typically requires complex and costly molding techniques which are difficult to put into practice on an industrial scale.

There is therefore a need for an improved solution which provides greater flexibility in terms of design and ergonomics, and which does not compromise frame robustness and lightweightness.

### SUMMARY OF THE INVENTION

A general aim of the invention is to provide such a wheelchair frame that provides greater flexibility in terms of design and ergonomics.

Yet another aim of the invention is to provide such a wheelchair frame that is more convenient to handle for the user.

A further aim of the invention is to provide such a wheelchair frame that is of lightweight and robust construction.

Still another aim of the invention is to provide such a wheelchair frame that is cost-efficient to produce.

These aims are achieved thanks to the solutions defined in the claims.

In accordance with the invention, there is provided a wheelchair frame as generally defined in claim 1, namely a wheelchair frame comprising first and second side frame members each comprising a first, rearward section designed to be coupled to a seat portion of a wheelchair and a second, forward section designed to be coupled to a foot portion of the wheelchair, wherein the rearward and forward sections are connected to one another to form a substantially L-shaped profile. Each of the first and second side frame members exhibits, at least in part, a varying cross-section and further comprises an intermediate section shaped to act as a hand grip, which intermediate section is interposed between the rearward and forward sections and exhibits a cross-section that differs from a cross-section of the rearward section and/or forward section. The rearward section, the intermediate section and the forward section are successive sections of a same integral piece that is shaped to exhibit the varying cross-section. The rearward section exhibits a substantially circular cross-section and the forward section exhibits a substantially polygonal cross-section. Furthermore, the intermediate section is a substantially rectilinear section and exhibits a varying cross-section transitioning gradually from the substantially circular cross-section of the rearward section to the substantially polygonal cross-section of the forward section.

In accordance with a particularly preferred embodiment, the first and second side frame members are made from tubular members shaped to exhibit the varying cross-section. These tubular members can in particular be made of aluminium. By way of preference, the first and second side frame members are hydroformed tubular members. The tubular members can especially be shaped to exhibit a substantially constant and uniform wall thickness.

The intermediate section preferably exhibits a length of the order of 100 mm. Furthermore, an angle of the intermediate section with respect to a horizontal, ground plane can in particular be comprised between 5° and 40°, and is preferably of the order of 25°.

In accordance with another embodiment of the invention, the rearward and forward sections are substantially rectilinear sections, and an angle of the rearward section with respect to a horizontal, ground plane is comprised between 0° and 40°, while an angle of the forward section with respect to the horizontal, ground plane is comprised between 55° and 90°.

Advantageously, the forward section may be designed to support a caster wheel support assembly. By way of preference, the forward section exhibits a substantially constant cross-section along at least a portion of the forward section, said portion of the forward section being designed to allow adjustment of a position of the caster wheel support assembly along the said portion.

According to yet another embodiment of the invention, the intermediate section exhibits, at least partly, a substantially polygonal cross-section. In this context, an upper portion of the intermediate section is preferably wider than a lower portion of the intermediate section. A width of a middle portion of the intermediate section, between the upper and lower portions, may furthermore be larger than a width of the upper and lower portions.

By way of preference, the intermediate section is shaped to provide an ergonomic grip.

Also claimed is a wheelchair comprising a wheelchair frame in accordance with the invention. By way of preference, the intermediate section of each of the first and second side frame members is located such as to project forward from a leading edge of the seat portion, thereby providing optimal hand grip positions for the user.

There is also provided a method of producing the aforementioned wheelchair frame, including the steps of (i) providing first and second tubular members and (ii) shaping the first and second tubular members into the first and second side frame members to form the rearward section, the intermediate section and the forward section. Preferably, shaping of the first and second tubular members into the first and second side frame members is performed by hydroforming.

Further advantageous embodiments of the invention are discussed below.

### BRIEF DESCRIPTION OF THE DRAWINGS

Other features and advantages of the present invention will appear more clearly from reading the following detailed description of embodiments of the invention which are presented solely by way of non-restrictive examples and illustrated by the attached drawings in which:

FIGS. 1A to 1F are perspective views of known commercially-available wheelchairs as sold by company Küschall AG;

FIG. 2 is a perspective view of a wheelchair comprising a wheelchair frame in accordance with a first embodiment of the present invention;

FIG. 3A is a schematic side view of a side frame member of the wheelchair frame of FIG. 2, as seen from the left;

FIGS. 3B and 3C are perspective views of the side frame member of FIG. 3A as seen from different viewing angles;

FIG. 3D is an enlarged side view of an intermediate section of the side frame member of FIG. 3A;

FIGS. 3E and 3F are perspective views of the intermediate section of FIG. 3D as seen from different viewing angles;

FIGS. 3G to 31 are cross-sectional views of the side frame member of FIG. 3A taken along three different sections of the side frame member, the relevant cross-sectional planes A-A, B-B and C-C being shown on FIG. 3D;

FIGS. 4A and 4B are photographic illustrations of a side frame member produced in accordance with the first embodiment of the invention;

FIG. 5A is a perspective view of a wheelchair comprising a wheelchair frame in accordance with a second embodiment of the present invention;

FIG. 5B is a perspective view of a wheelchair comprising a wheelchair frame in accordance with a third embodiment of the present invention;

FIG. 6 is a schematic side view of a side frame member of the wheelchair frame of FIG. 5A or 5B, as seen from the left;

FIGS. 7A and 7B are photographic illustrations of a side frame member produced in accordance with the second embodiment of the invention;

FIGS. 8A and 8B are photographic illustrations of a side frame member produced in accordance with the third embodiment of the invention;

FIG. 9 is a schematic side view of a side frame member of a wheelchair frame in accordance with a fourth embodiment of the invention, as seen from the left;

FIG. 10 is a photographic illustration of a front-end of a wheelchair frame of a wheelchair showing a side frame member produced in accordance with the fourth embodiment of the invention;

FIG. 11 is a perspective view of a wheelchair comprising a wheelchair frame in accordance with a fifth embodiment of the present invention;

FIG. 12 is a schematic side view of a side frame member of the wheelchair frame of FIG. 11, as seen from the left; and

FIG. 13 is a photographic illustration of a front-end of a wheelchair frame of a wheelchair showing a side frame member produced in accordance with the fifth embodiment of the invention.

### DETAILED DESCRIPTION OF EMBODIMENTS OF THE INVENTION

The present invention will be described in relation to various illustrative embodiments. It shall be understood that the scope of the invention encompasses all combinations and sub-combinations of the features of the embodiments disclosed herein.

As described herein, when two or more parts or components are described as being connected, secured or coupled to one another, they can be so connected, secured or coupled directly to each other or through one or more intermediary parts.

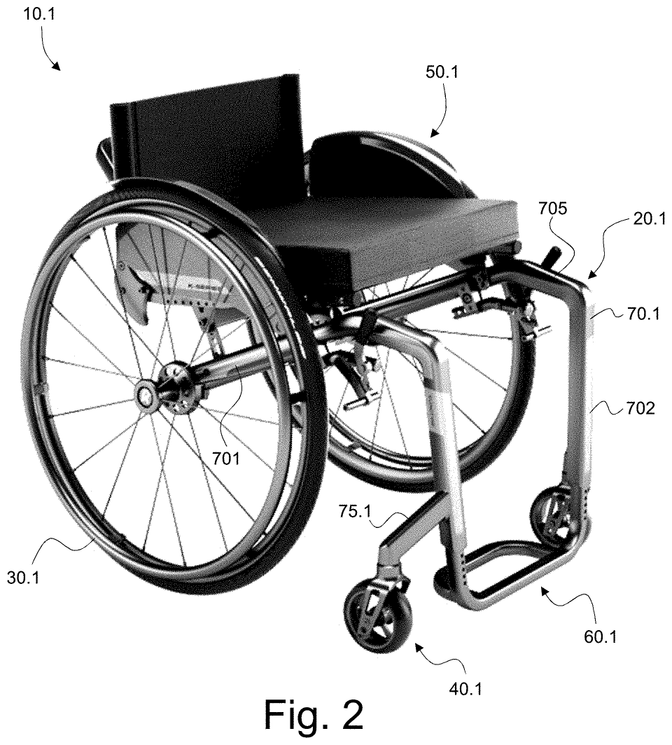

The invention will be described in relation to various embodiments of a wheelchair frame as depicted in FIGS. 2 to 13.

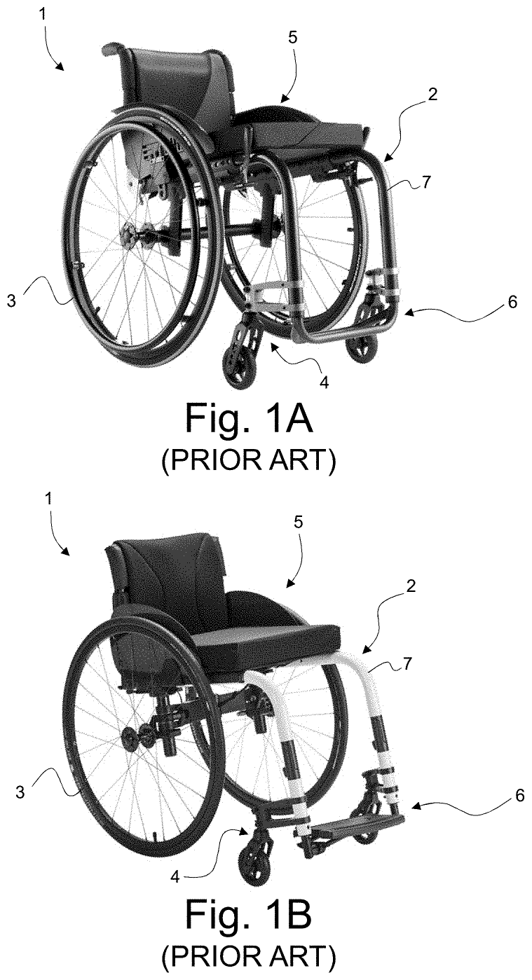

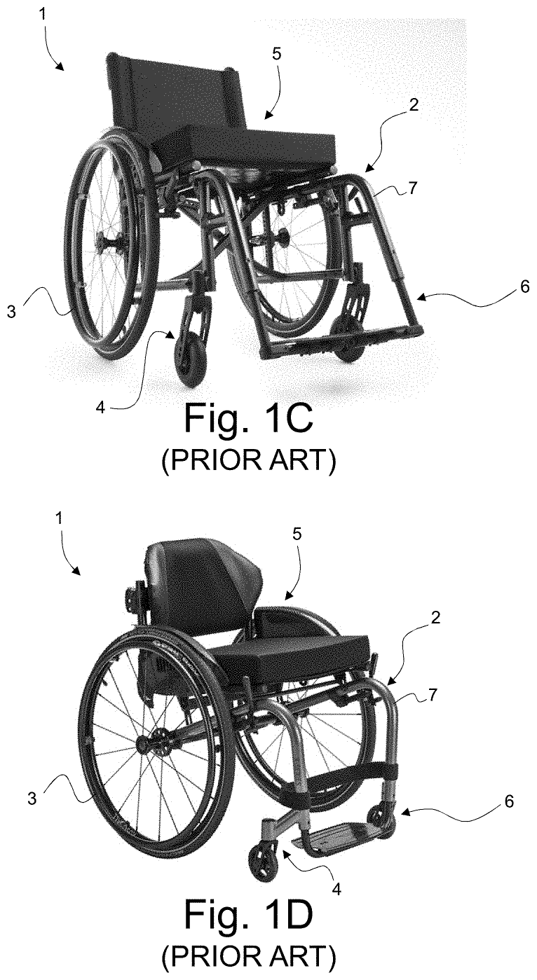

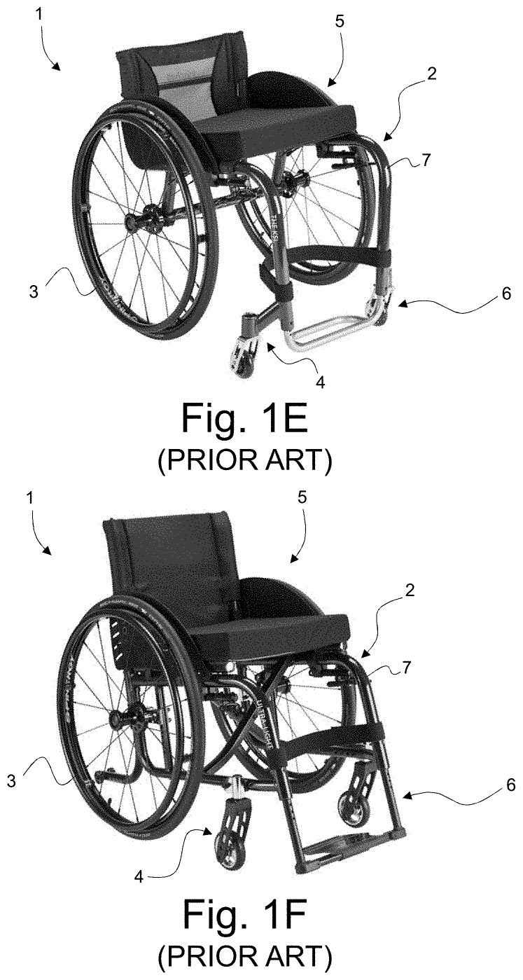

FIG. 2 is a perspective view of a wheelchair, designated generally by reference numeral 10.1, comprising a wheelchair frame 20.1 in accordance with a first embodiment of the present invention. In a manner similar to the known wheelchair of FIG. 1D, the wheelchair frame 20.1 is supported at a rear-end by a pair of rear wheels 30.1 and at a front-end by a pair of front caster wheel support assemblies 40.1. The wheelchair frame 20.1 likewise comprises two side frame members 70.1 (one on each side) each comprising a first, rearward section 701 designed to be coupled to a seat portion 50.1 of the wheelchair 10.1 and a second, forward section 702 designed to be coupled to a foot portion 60.1 of the wheelchair 10.1. The rearward and forward sections 701, 702 of the side frame members 70.1 are connected to one another to form a substantially L-shaped profile. In the illustrated first embodiment, the rearward section 701 connects directly to the rear axle, while the forward section 702 couples to a corresponding one of two ends of a substantially U-shaped element forming the foot portion 60.1. It may further be appreciated that the forward section 702 is designed here to support the caster wheel support assembly 40.1. More precisely, the forward section 702 is provided with an extension 75.1 that provides support for attachment of the caster wheel support assembly 40.1.

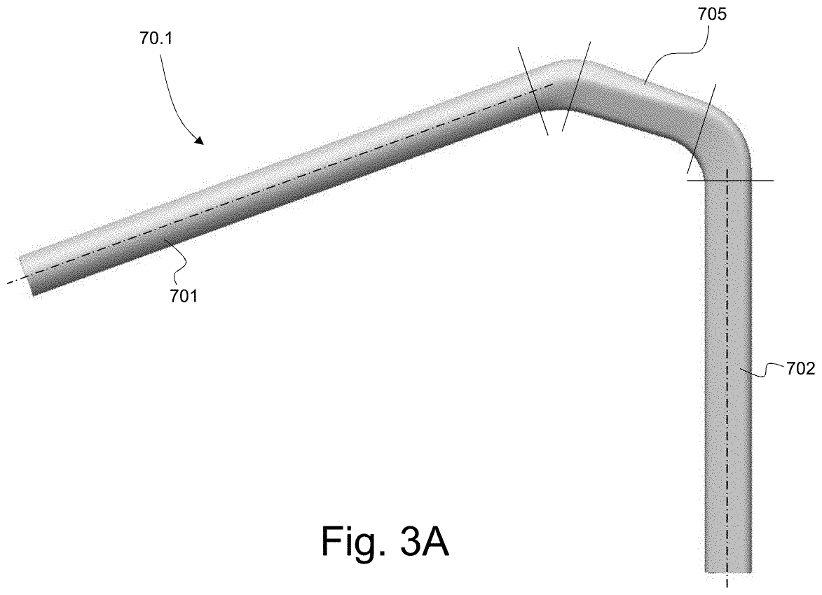

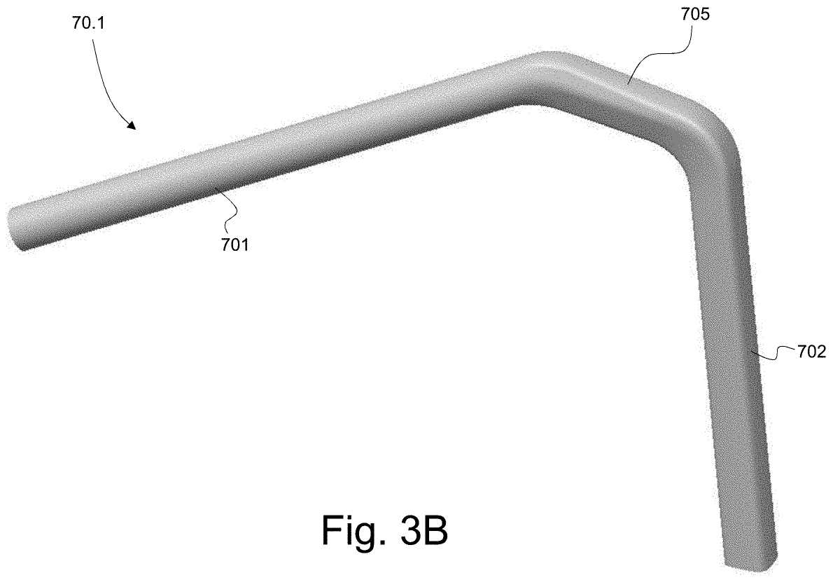

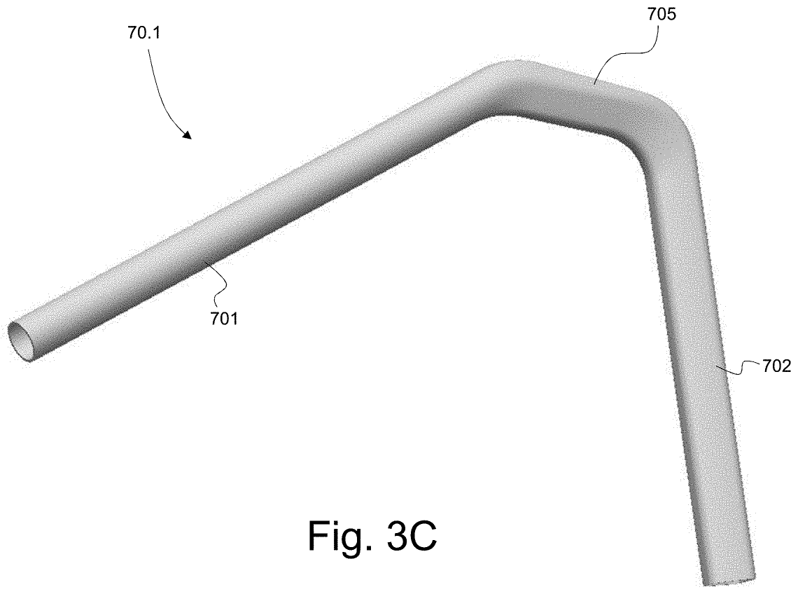

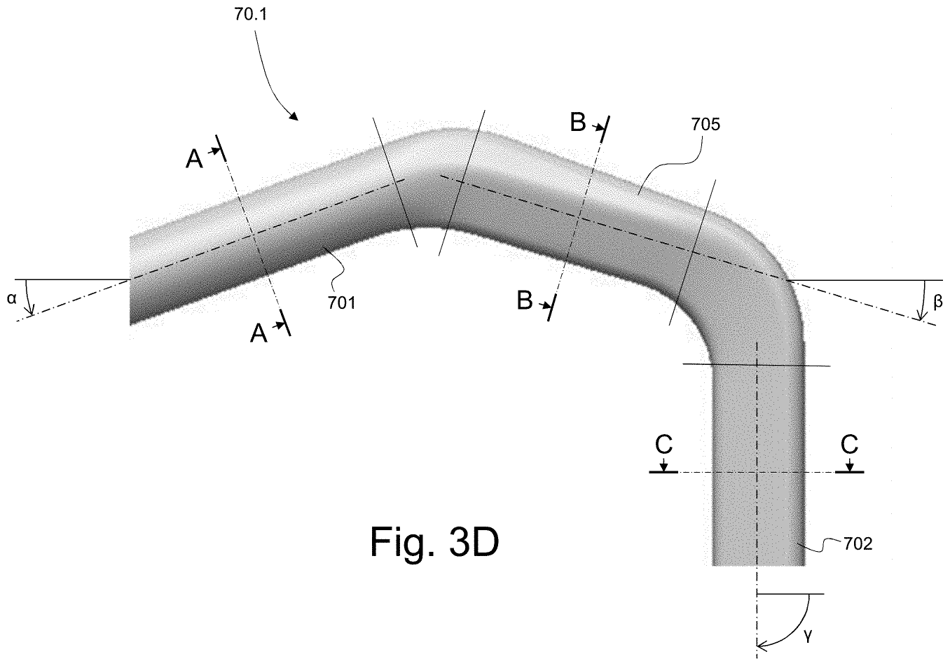

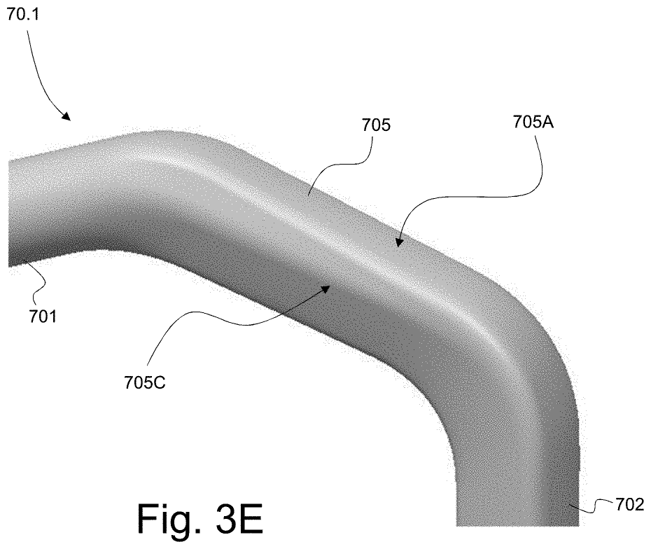

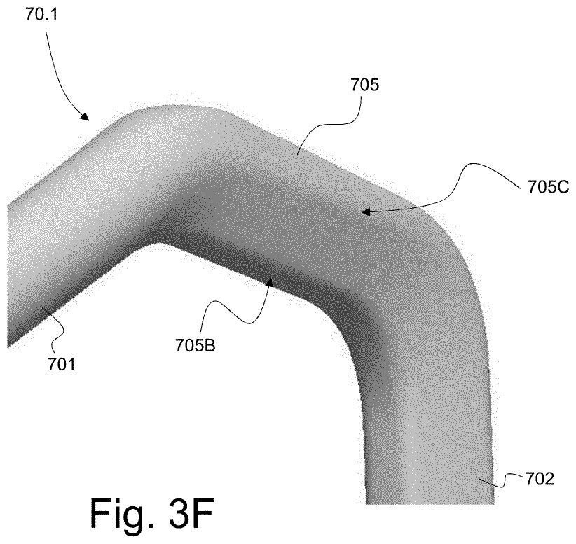

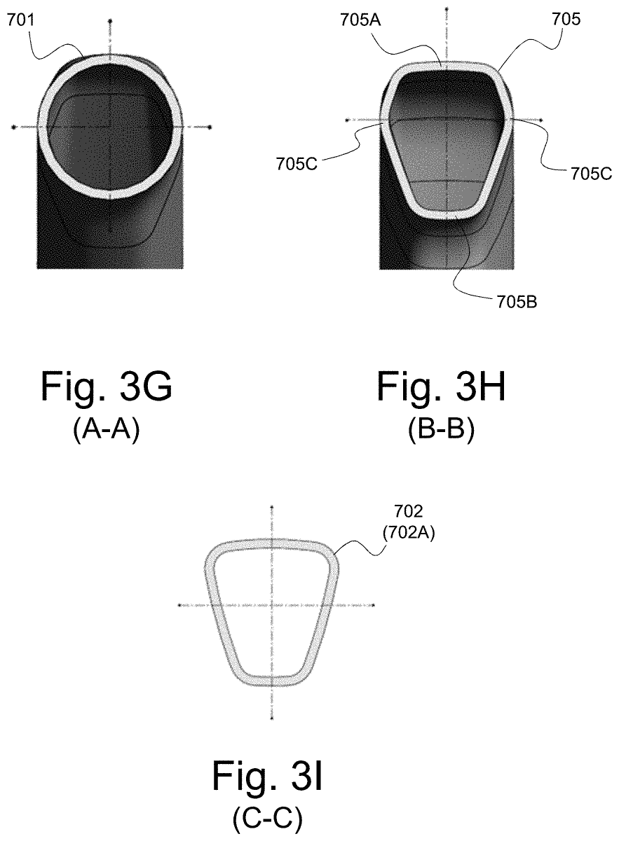

According to the present invention, each of the first and second side frame members 70.1 exhibits, at least in part, a varying cross-section and further comprises an intermediate section, designated by reference numeral 705, which intermediate section 705 is shaped to act as a hand grip. This intermediate section 705 is interposed between the rearward and forward sections 701, 702 and exhibits a cross-section that differs, in the illustrated example, from a cross-section of the rearward and forward sections 701, 702. Furthermore, the rearward section 701, the intermediate section 705 and the forward section 702 are successive sections of a same integral piece that is shaped to exhibit a varying cross-section as illustrated in greater detail in FIGS. 3A-31 and 4A-B.

In accordance with a preferred embodiment of the invention, which applies to all illustrated embodiments shown in FIGS. 2 to 13, the first and second side frame members are made from tubular members shaped to exhibit the varying cross-section. These tubular members can in particular be made of aluminium, which material is perfectly suited for the intended purpose.

In accordance with a particularly preferred embodiment of the invention, the first and second side frame members are hydroformed tubular members, i.e. tubular members that have been shaped to the desired configuration by hydroforming. Hydroforming is a very cost-efficient process, in the present instance, to shape the relevant tubular member into successive sections of varying cross-section. Pre-bending of the relevant tubular member may be carried out, prior to the hydroforming process, to generally match the desired frame member profile. This allows complex shapes to be produced without compromising lightweightness and robustness of the relevant frame member, and is therefore perfectly suited to the production of the side frame members of the wheelchair frame of the present invention.

By way of preference, the tubular members are shaped to exhibit a substantially constant and uniform wall thickness, which ensures optimal robustness and rigidity.

FIG. 3A is a schematic side view of one side frame member 70.1 of the wheelchair frame 20.1 of FIG. 2, as seen from the left, including the rearward section 701, the intermediate section 705, and the forward section 702. FIGS. 3B and 3C are perspective views of the side frame member 70.1 as seen from different viewing angles. Not shown in FIGS. 3A-3C is the aforementioned extension 75.1, which is optional.

In accordance with the invention as illustrated, it will be appreciated that the rearward section 701 exhibits a substantially circular cross-section (see also FIGS. 3D and 3G), while the forward section 702 exhibits a non-circular cross-section, namely a substantially polygonal cross-section with four distinct faces in the present instance (see also FIGS. 3D and 3I). Furthermore, the intermediate section 705 exhibits a varying cross-section transitioning (or morphing) gradually from the substantially circular cross-section of the rearward section 701 to the substantially polygonal cross-section of the forward section 702 (see also FIGS. 3D to 3I).

The intermediate section 705 is preferably shaped to provide an ergonomic grip. By way of preference, the intermediate section 705 exhibits, at least in part, a substantially polygonal cross-section. FIGS. 3E, 3F and 3H show that an upper portion 705A of the intermediate section 705 is wider than a lower portion 705B of the intermediate section 705, with a middle portion 705C of the intermediate section, between the upper and lower portions 705A, 705B, being advantageously larger than a width of the upper and lower portions 705A, 705B. This ensures perfect grip for the user upon grabbing the intermediate section 705.

In accordance with the invention, the intermediate section 705 is a substantially rectilinear section and preferably exhibits a length of the order of 100 mm, which is suitable to act as hand grip. More particularly, as illustrated in FIG. 3D, an angle β of the intermediate section 705 with respect to a horizontal, ground plane is comprised between 5° and 40°, and is preferably of the order of 25°.

The rearward and forward sections 701, 702 can likewise be shaped as substantially rectilinear sections. In that context, an angle α of the rearward section 701 with respect to the horizontal, ground plane is preferably comprised between 0° and 40°, and an angle γ of the forward section 702 with respect to the horizontal, ground plane is preferably comprised between 55° and 90°. In the illustration of FIG. 3A, angles α and γ are of the order of 25° and 90°, respectively.

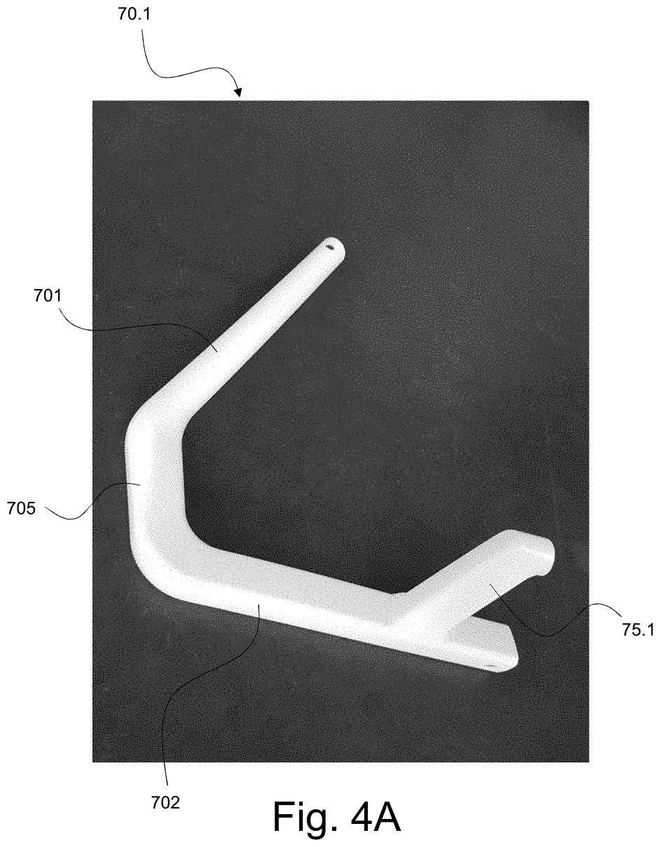

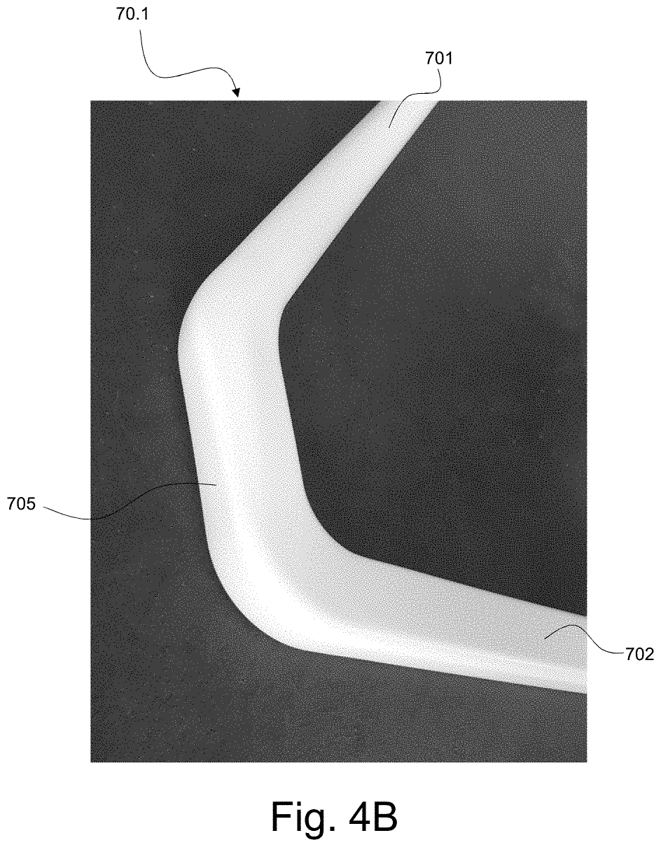

FIGS. 4A and 4B are photographic illustrations of a side frame member 70.1 produced in accordance with the first embodiment of the invention. As mentioned hereabove, the side frame member 70.1 shown in FIGS. 4A and 4B is a hydroformed tubular member that was shaped into the successive sections 701, 705, 702 of varying cross-section. The extension 75.1, which could likewise be produced by hydroforming, was subsequently welded onto the forward section 702.

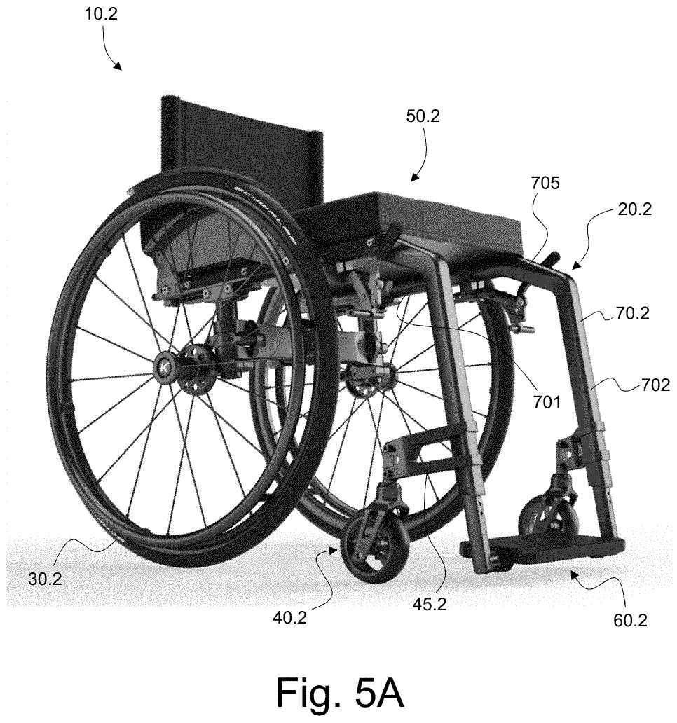

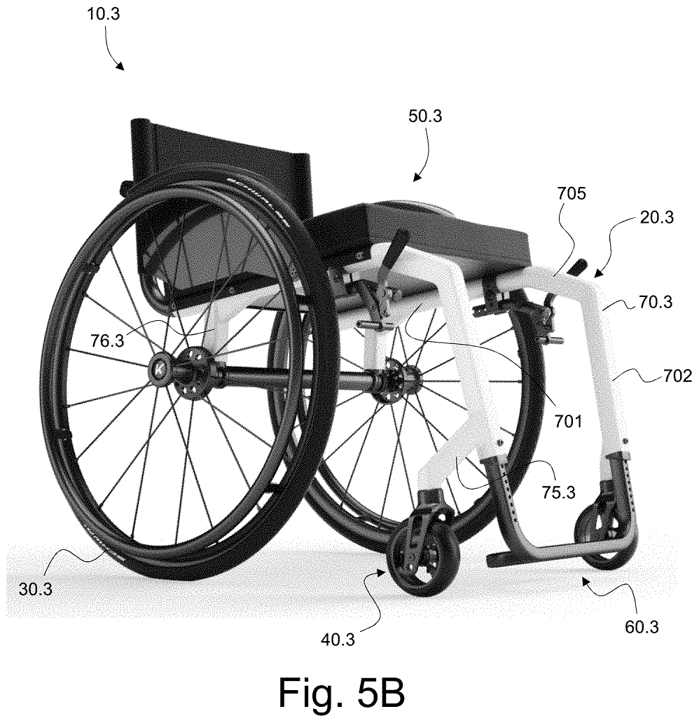

FIGS. 5A and 5B are perspective views of a wheelchair 10.2, respectively 10.3, comprising a wheelchair frame 20.2, resp. 20.3, in accordance with second and third embodiments of the present invention. The wheelchair frame 20.2, resp. 20.3, is similarly supported at a rear-end by a pair of rear wheels 30.2, resp. 30.3, and at a front-end by a pair of front caster wheel support assemblies 40.2, resp. 40.3. The wheelchair frame 20.2, resp. 20.3, likewise comprises two side frame members 70.2, resp. 70.3, (one on each side) each comprising a first, rearward section 701 designed to be coupled to a seat portion 50.2, resp. 50.3, of the wheelchair 10.2, resp. 10.3, and a second, forward section 702 designed to be coupled to a foot portion 60.2, resp. 60.3, of the wheelchair 10.2, resp. 10.3. The rearward and forward sections 701, 702 of the side frame members 70.2, resp. 70.3, are once again connected to one another to form a substantially L-shaped profile.

As far as the wheelchair 10.2 of FIG. 5A is concerned, the wheelchair frame 20.2 is designed to be foldable and, in contrast to the first embodiment of FIG. 2 and the third embodiment of FIG. 5B, is not coupled to a rigid rear axle. Rather, the rearward section 701 of each side frame member 70.2 is coupled to a corresponding hub of each rear wheel 30.2 and a foldable mechanism is provided between the rear wheels 30.2, as is known in the art, for instance from Küschall's Champion wheelchair as depicted in FIG. 1B. Furthermore, the front caster wheel support assemblies 40.2 each comprise a support member 45.2 configured to be securable to a portion of the forward section 702 of the side frame member 70.2. The front caster wheel support assemblies 40.2 can in particular be designed in accordance with the principles set forth in European Patent Application No. 18192870.6 of Sep. 6, 2018 in the name of the present Applicant and titled “CASTER WHEEL SUPPORT ASSEMBLY FOR A WHEELCHAIR AND WHEELCHAIR COMPRISING THE SAME”, the content of which is incorporated herein by reference in its entirety.

As regards the wheelchair 10.3 of FIG. 5B, the rearward section 701 of each side frame member 70.3 is further provided with an extension 76.3 for coupling to a rigid rear axle provided between the rear wheels 30.3. In a manner similar to the first embodiment of FIG. 2, the forward section 702 of the side frame member 70.3 is provided with an extension 75.3 that provides support for attachment of the caster wheel support assembly 40.3.

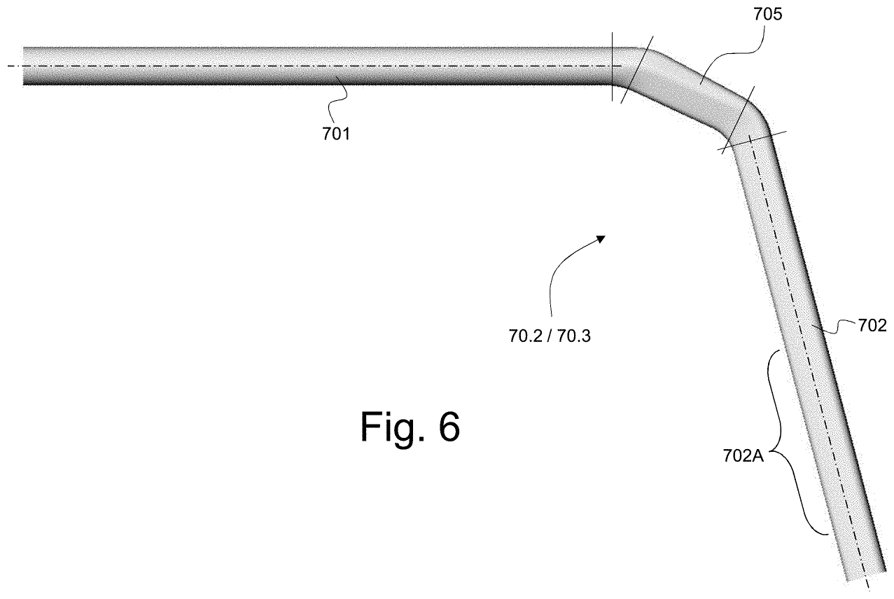

FIG. 6 is a schematic side view of one side frame member 70.2, resp. 70.3 of the wheelchair frame 20.2, resp. 20.3, of FIGS. 5A-B, as seen from the left, including the rearward section 701, the intermediate section 705, and the forward section 702. Not shown in FIG. 6 are the aforementioned extensions 75.3, 76.3, which are likewise optional.

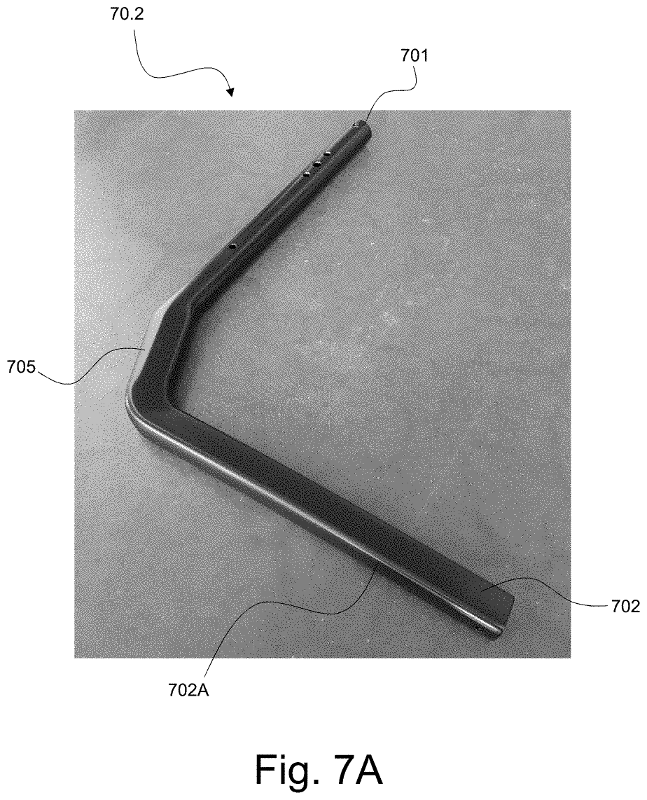

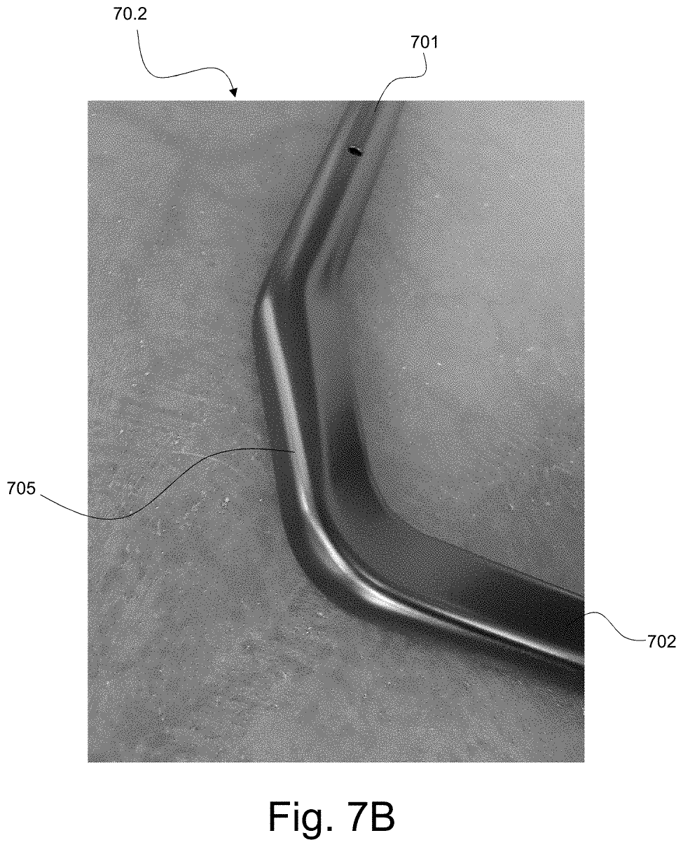

The configuration of the side frame member 70.2, resp. 70.3, is similar to that of side frame member 70.1, the main difference residing in the angle α formed by the rearward section 701, which is of the order of 0° in this other example, and the angle γ formed by the forward section 702, which is of the order of 80°. Furthermore, in the present instance, the forward section 702 preferably exhibits a substantially constant cross-section along at least a portion 702A of the forward section 702. This portion 702A is designed to allow adjustment of a position of the caster wheel support assembly (e.g. 40.2) along the portion 702A, in the event that the caster wheel support assembly is mounted directly on the forward section 702, as shown for instance in FIG. 5A (see also FIG. 7A).

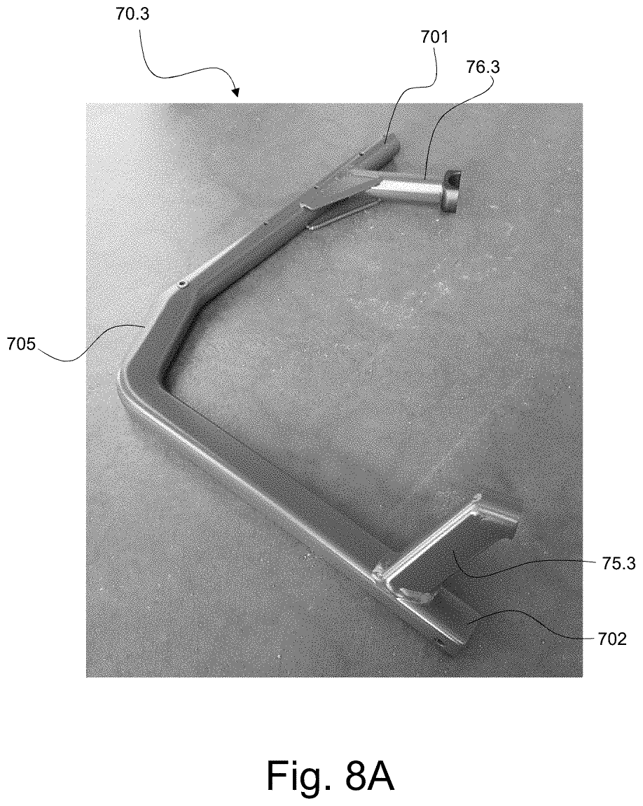

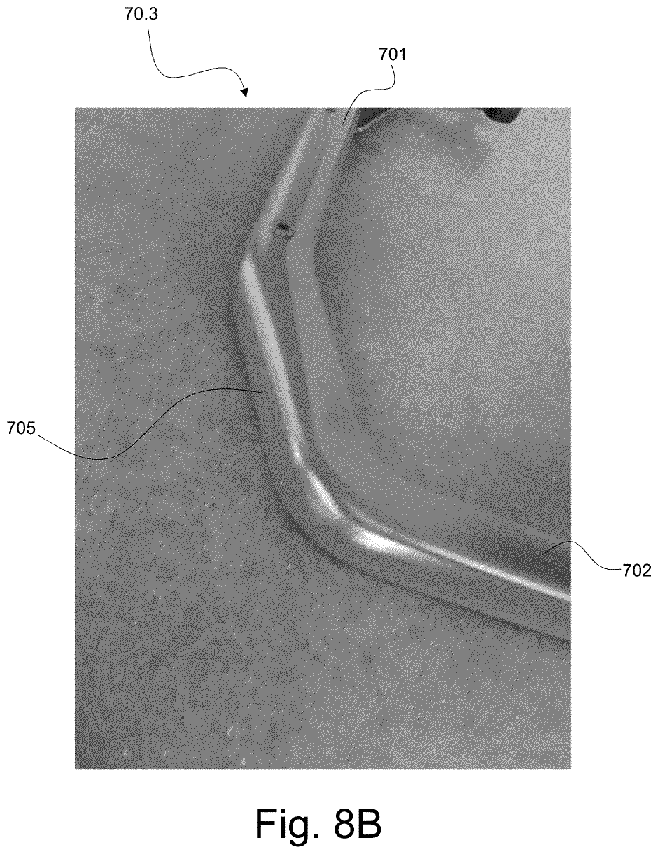

FIGS. 7A-B and 8A-B are photographic illustrations of a side frame member 70.2, resp. 70.3, produced in accordance with the second and third embodiments of the invention. As mentioned hereabove, the side frame member 70.2, resp. 70.3, shown in FIGS. 7A-B and 8A-B are hydroformed tubular members that were shaped into the successive sections 701, 705, 702 of varying cross-section. With respect to the side frame member 70.3 shown in FIGS. 8A-B, the extensions 75.3, 76.3 were subsequently welded onto the forward section 702 and reward section 701, respectively.

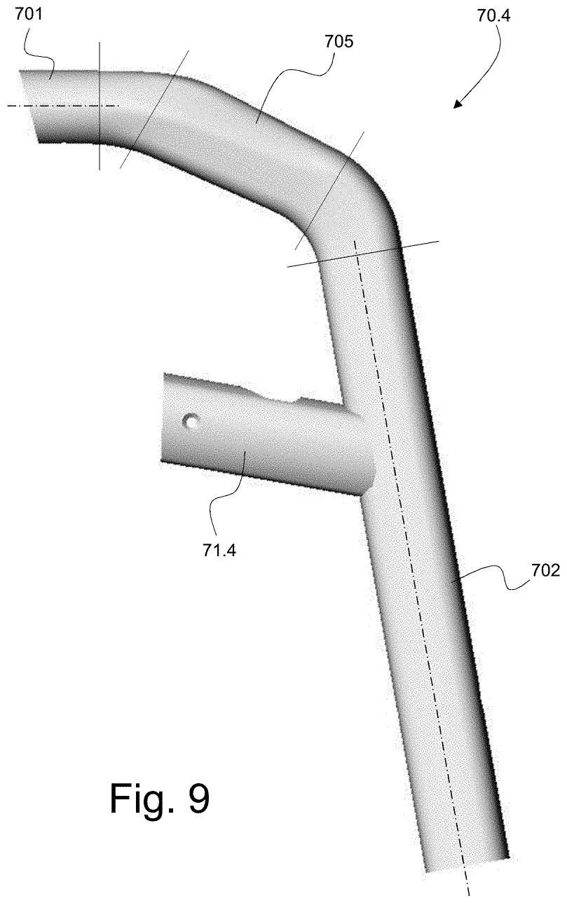

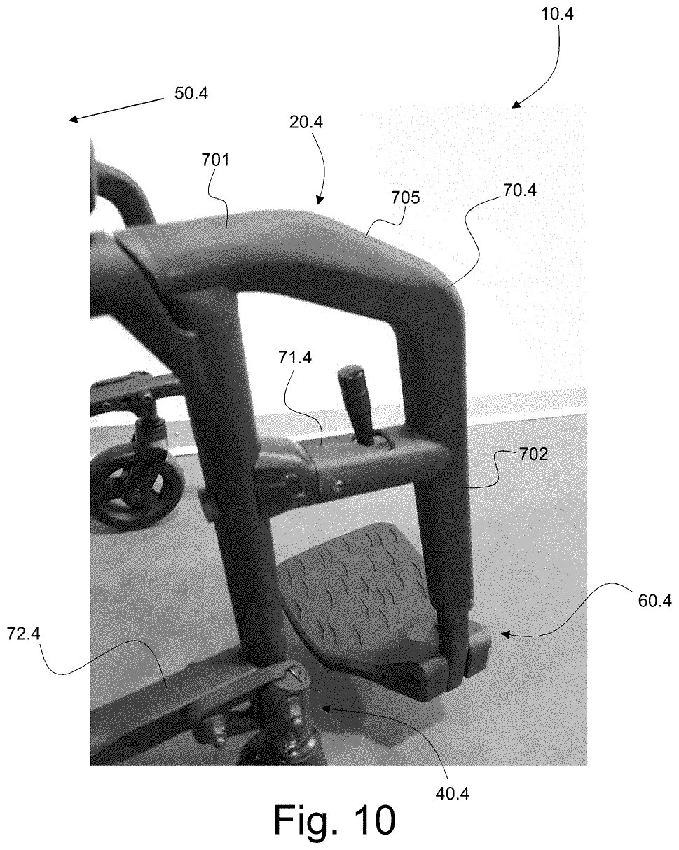

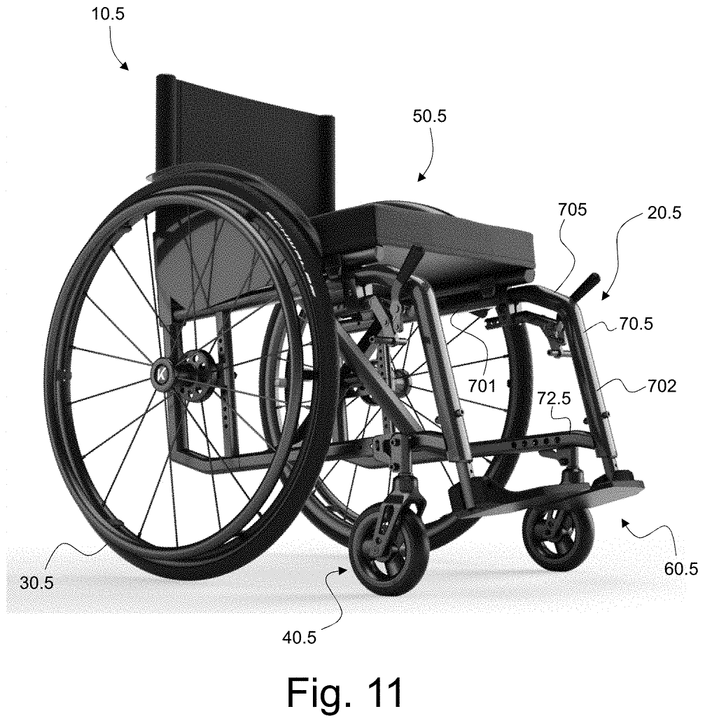

FIG. 9 is a schematic side view of a side frame member 70.4 of a wheelchair frame in accordance with a fourth embodiment of the invention, as seen from the left, including the rearward section 701, the intermediate section 705, and the forward section 702. FIG. 9 further shows that the forward section 702 is provided with an extension 71.4 extending rearward, in substantially the same direction as the rearward section 701. This extension is used for the purpose of securing the side frame member 70.4 to a front-end of a wheelchair 10.4, as depicted in the photographic illustration of FIG. 10. In accordance with this fourth embodiment, the side frame member 70.4 is designed to act as swivelling leg rest support, as is known in the art, for instance from Küschall's Compact wheelchair as depicted in FIG. 1C. In contrast to the previous embodiments, the front caster wheel support assembly 40.4 is not secured to the side frame member 70.4, but to a separate side frame member 72.4 (see FIG. 10). The front caster wheel support assembly 40.4 can also be designed in accordance with the principles set forth in the aforementioned European Patent Application No. 18192870.6 of Sep. 6, 2018 in the name of the present Applicant. In addition, as shown in the photographic illustration of FIG. 10, a foldable foot rest is provided at the foot portion 60.4, which foot rest is secured to the end of the forward section 702 (see also FIG. 11 where a similar foot rest arrangement is depicted).

FIG. 11 is a perspective view of a wheelchair 10.5 comprising a wheelchair frame 20.5 in accordance with a fifth embodiment of the present invention. The wheelchair frame 20.5 is similarly supported at a rear-end by a pair of rear wheels 30.5 and at a front-end by a pair of front caster wheel support assemblies 40.5. The wheelchair frame 20.5 likewise comprises two side frame members 70.5 (one on each side) each comprising a first, rearward section 701 designed to be coupled to a seat portion 50.5 of the wheelchair 10.5 and a second, forward section 702 designed to be coupled to a foot portion 60.5 of the wheelchair 10.5. The rearward and forward sections 701, 702 of the side frame members 70.5 are once again connected to one another to form a substantially L-shaped profile. In a manner similar to the fourth embodiment, the front caster wheel support assembly 40.5 is not secured to the side frame member 70.5, but to a separate side frame member 72.5. The front caster wheel support assembly 40.5 can likewise be designed in accordance with the principles set forth in the aforementioned European Patent Application No. 18192870.6 of Sep. 6, 2018 in the name of the present Applicant.

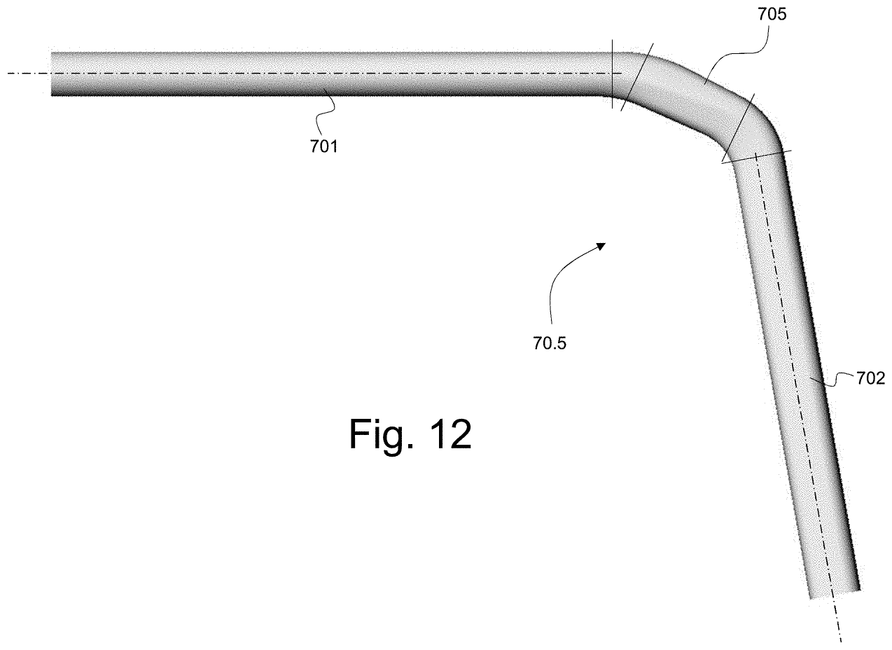

FIG. 12 is a schematic side view of one side frame member 70.5 of the wheelchair frame 20.5 of FIG. 11, as seen from the left, including the rearward section 701, the intermediate section 705, and the forward section 702. The configuration of the side frame member 70.5 is similar to that of side frame members 70.2, 70.3 shown in FIG. 6.

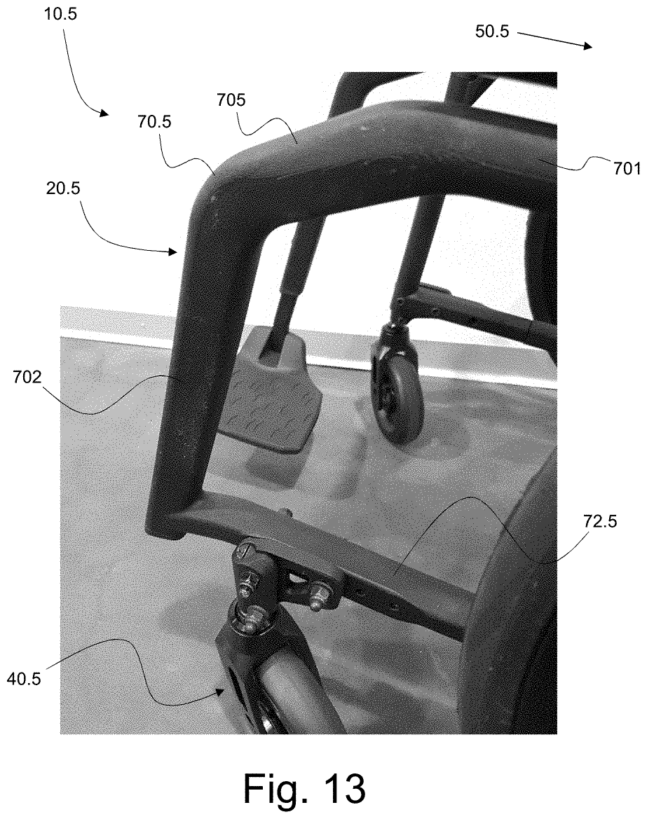

FIG. 13 is a photographic illustration of a front-end of a wheelchair frame 20.5 of a wheelchair 10.5 showing a side frame member 70.5 produced in accordance with the fifth embodiment of the invention. FIG. 13 also shows the additional side frame member 72.5 welded at one end of the forward section 702 of the side frame member 70.5, which additional side frame member 72.5 carries the front caster wheel support assembly 40.5.

Looking at the illustrations of FIGS. 2, 5A, 5B, 10, 11 and 13, it may be noted that the intermediate section 705 of side frame member 70.1, 70.2, 70.3, 70.4, respectively 70.5, is optimally located such as to project forward from a leading edge of the relevant seat portion 50.1, 50.2, 50.3, 50.4, resp. 50.5, thereby providing adequate hand grip positions for the user.

Various modifications and/or improvements may be made to the above-described embodiments without departing from the scope of the invention as defined by the annexed claims. For instance, the rearward section 701 and/or forward section 702 could be provided with any additional extension as shown by way of illustration in FIGS. 2, 4A, 5A-B, 8A and 9-10 and/or be secured to additional frame members as shown in FIGS. 10, 11 and 12.

### LIST OF REFERENCE NUMERALS AND SIGNS USED THEREIN

1 prior art wheelchair
2 wheelchair frame of wheelchair 1
3 rear wheels of wheelchair 1
4 front caster wheels of wheelchair 1
5 seat portion of wheelchair 1
6 foot portion of wheelchair 1
7 side frame members of wheelchair frame 2
10.1 wheelchair (first embodiment)
20.1 wheelchair frame of wheelchair 10.1
30.1 rear wheels of wheelchair 10.1
40.1 caster wheel support assembly of wheelchair 10.1
50.1 seat portion of wheelchair 10.1
60.1 foot portion of wheelchair 10.1
70.1 side frame members of wheelchair frame 20.1
75.1 extension of side frame member 70.1 supporting caster wheel support assembly 40.1
10.2 wheelchair (second embodiment)
20.2 wheelchair frame of wheelchair 10.2
30.2 rear wheels of wheelchair 10.2
40.2 caster wheel support assembly of wheelchair 10.2
45.2 support member of caster wheel support assembly 40.2 (slidably adjustable along portion
702A of forward section 702 of side frame member 70.2)
50.2 seat portion of wheelchair 10.2
60.2 foot portion of wheelchair 10.2
70.2 side frame members of wheelchair frame 20.2
10.3 wheelchair (third embodiment)
20.3 wheelchair frame of wheelchair 10.3
30.3 rear wheels of wheelchair 10.3
40.3 caster wheel support assembly of wheelchair 10.3
50.3 seat portion of wheelchair 10.3
60.3 foot portion of wheelchair 10.3
70.3 side frame members of wheelchair frame 20.3
75.3 extension of side frame member 70.3 supporting caster wheel support assembly 40.3
76.3 extension of side frame member 70.3 for coupling to rear wheel axle
10.4 wheelchair (fourth embodiment)
20.4 wheelchair frame of wheelchair 10.4
40.4 caster wheel support assembly of wheelchair 10.4
60.4 foot portion of wheelchair 10.4
70.4 side frame members of wheelchair frame 20.4 (swivelling leg rest supports)
71.4 extension of side frame member 70.4 for securing side frame members 70.4 to front-end of wheelchair 10.4
72.4 additional side frame members of wheelchair frame 20.4
10.5 wheelchair (fifth embodiment)
20.5 wheelchair frame of wheelchair 10.5
30.5 rear wheels of wheelchair 10.5
40.5 caster wheel support assembly of wheelchair 10.5
50.5 seat portion of wheelchair 10.5
60.5 foot portion of wheelchair 10.5
70.5 side frame members of wheelchair frame 20.5
72.5 additional side frame members of wheelchair frame 20.5
701 rearward section of side frame member 70.1, 70.2, 70.3, 70.4, 70.5
702 forward section of side frame member 70.1, 70.2, 70.3, 70.4, 70.5
702A portion of forward section 702 of side frame member 70.2 exhibiting a substantially constant cross-section (second embodiment)
705 intermediate section of side frame member 70.1, 70.2, 70.3, 70.4, 70.5 acting as hand grip
705A upper portion of intermediate section 705
705B lower portion of intermediate section 705
705C middle portion of intermediate section 705

1-19. (canceled)

20. A wheelchair frame comprising first and second side frame members each comprising a first, rearward section designed to be coupled to a seat portion of a wheelchair and a second, forward section designed to be coupled to a foot portion of the wheelchair, wherein the rearward and forward sections are connected to one another to form a substantially L-shaped profile,
wherein each of the first and second side frame members exhibits, at least in part, a varying cross-section and further comprises an intermediate section shaped to act as a hand grip, which intermediate section is interposed between the rearward and forward sections and exhibits a cross-section that differs from a cross-section of the rearward section and/or forward section,
wherein the rearward section, the intermediate section and the forward section are successive sections of a same integral piece that is shaped to exhibit the varying cross-section,
wherein the rearward section exhibits a substantially circular cross-section,
wherein the forward section exhibits a substantially polygonal cross-section,
wherein the intermediate section is a substantially rectilinear section,
and wherein the intermediate section exhibits a varying cross-section transitioning gradually from the substantially circular cross-section of the rearward section to the substantially polygonal cross-section of the forward section.

21. The wheelchair frame according to claim 20, wherein the first and second side frame members are made from tubular members shaped to exhibit the varying cross-section.

22. The wheelchair frame according to claim 21, wherein the tubular members are made of aluminum.

23. The wheelchair frame according to claim 21, wherein the first and second side frame members are hydroformed tubular members.

24. The wheelchair frame according to claim 21, wherein the tubular members are shaped to exhibit a substantially constant and uniform wall thickness.

25. The wheelchair frame according to claim 20, wherein the intermediate section exhibits a length of the order of 100 mm.

26. The wheelchair frame according to claim 20, wherein an angle of the intermediate section with respect to a horizontal, ground plane is comprised between 5° and 40°.

27. The wheelchair frame according to claim 26, wherein the angle of the intermediate section with respect to the horizontal, ground plane is of the order of 25°.

28. The wheelchair frame according to claim 20, wherein the rearward and forward sections are substantially rectilinear sections,
wherein an angle of the rearward section with respect to a horizontal, ground plane is comprised between 0° and 40°,
and wherein an angle of the forward section with respect to the horizontal, ground plane is comprised between 55° and 90°.

29. The wheelchair frame according to claim 20, wherein the forward section is designed to support a caster wheel support assembly.

30. The wheelchair frame according to claim 29, wherein the forward section exhibits a substantially constant cross-section along at least a portion of the forward section, said portion of the forward section being designed to allow adjustment of a position of the caster wheel support assembly along the said portion.

31. The wheelchair frame according to claim 20, wherein the intermediate section exhibits, at least partly, a substantially polygonal cross-section.

32. The wheelchair frame according to claim 31, wherein an upper portion of the intermediate section is wider than a lower portion of the intermediate section.

33. The wheelchair frame according to claim 32, wherein a width of a middle portion of the intermediate section, between the upper and lower portions, is larger than a width of the upper and lower portions.

34. The wheelchair frame according to claim 20, wherein the intermediate section is shaped to provide an ergonomic grip.

35. A wheelchair comprising a wheelchair frame in accordance with claim 20.

36. The wheelchair according to claim 35, wherein the intermediate section of each of the first and second side frame members is located such as to project forward from a leading edge of the seat portion.

37. A wheelchair comprising a wheelchair frame with first and second side frame members each comprising a first, rearward section designed to be coupled to a seat portion of the wheelchair and a second, forward section designed to be coupled to a foot portion of the wheelchair, wherein the rearward and forward sections are connected to one another to form a substantially L-shaped profile,
wherein each of the first and second side frame members exhibits, at least in part, a varying cross-section and further comprises an intermediate section shaped to act as a hand grip, which intermediate section is interposed between the rearward and forward sections and exhibits a cross-section that differs from a cross-section of the rearward section and/or forward section,
wherein the rearward section, the intermediate section and the forward section are successive sections of a same integral piece that is shaped to exhibit the varying cross-section,
and wherein the intermediate section of each of the first and second side frame members is located such as to project forward from a leading edge of the seat portion.

38. The wheelchair frame according to claim 37, wherein the first and second side frame members are made from tubular members shaped to exhibit the varying cross-section.

39. The wheelchair frame according to claim 38, wherein the tubular members are made of aluminum.

40. The wheelchair frame according to claim 38, wherein the first and second side frame members are hydroformed tubular members.

41. A method of producing the wheelchair frame in accordance with claim 20, including the steps of:
providing first and second tubular members;
shaping the first and second tubular members into the first and second side frame members to form the rearward section, the intermediate section and the forward section.

42. The method according to claim 41, wherein shaping of the first and second tubular members into the first and second side frame members is performed by hydroforming.
